(19) United States
(12) Patent Application Publication
(10) Pub. No.: US 2011/0024925 A1
(43) Pub. Date: Feb. 3, 2011

(54) POURER

(75) Inventor: Claude Mauffette, Montreal (CA)

Correspondence Address: WOOD, HERRON & EVANS, LLP, 2700 CAREW TOWER, 441 VINE STREET, CINCINNATI, OH, 45202, US

(73) Assignee: LE CREUSET SAS, Fresnoy le Grand (FR)

(21) Appl. No.: 12/934,289

(22) PCT Filed: Mar. 31, 2008
(86) PCT No.: PCT/IB08/01684

§ 371 Date: Sep. 24, 2010

(51) Int. Cl. B01F 3/04

(52) U.S. Cl. 261/76

(57) ABSTRACT

A device for simultaneously pouring a liquid from a bottle (50) into a vessel (52) and mixing air into the liquid comprises bottle engaging means for engaging the neck of a bottle (50), vessel engaging means for engaging the vessel (52), a liquid flow passage (68) for flow of liquid from the bottle (50) to the vessel (52), an air return passage (34, 36) for flow of air from the vessel (52) to the bottle (50), and a liquid distributor (18) for distributing liquid in a path into the vessel.

### FIELD OF THE INVENTION

The present invention relates to a device for enhancing the flavors of liquids, especially wine. More particularly, and in its preferred intended use, the present invention relates to a wine aerator

### BACKGROUND OF THE INVENTION

The benefits of aerating wine in decanters and the like are very well known in the art.

Decanters are vessels used to hold the results of decantation, a process in which liquid from another vessel, for example a wine bottle, is poured into the decanter so as to separate the sediment commonly found at the bottom of old red wines from the wine itself so as to prevent the sediment from spoiling the wine's clarity and brilliance.

Another increasingly popular use of decanters is the oxygenation, more commonly referred to as the aeration or “breathing”, of wines. By maximizing the exposure of the wine to the surrounding air, the wine's aromas will open and the flavors of the wine will further be released. While virtually all wines can benefit from being aerated, the process is especially beneficial for young red wines whose sharpness and high tannin levels are softened by the process.

The simplest form of aeration is to simply uncork the wine for a period of time prior to consuming in order to allow air to flow in and out of the bottle and interact with the wine at its exposed surface. By transferring the wine to a decanter, which typically comprises a widehollow body below an open neck, the upper surface of the wine in the decanter, i.e. that which is exposed to the air, is greatly increased and the wine can be left to interact with the air more effectively.

In addition, the wine may be poured into the decanter such that it flows down the neck and side walls thereof, and furthermore swirled about within a decanter by gripping the decanter by its neck and rotating the rotating the decanter in the air, forcing the wine up the sides of the decanter and exposing even more wine to the air. Wine poured into a wine glass may similarly be swirled.

It is further known to insert funnel-type aerators and the like into the mouth of a decanter in order to distribute the wine about the decanter as it is poured therein.

Also known in the art are the various disadvantages associated with these types of funnels and the like. For example, it is known that agitating wine too violently in an attempt to promote aeration can in fact damage the wine. This effect is commonly known as “bruising”.

### SUMMARY OF THE INVENTION

In accordance with the present invention, there is provided a device for simultaneously pouring a liquid from a bottle into a vessel and mixing air into the liquid comprising bottle engaging means for engaging the neck of a bottle, vessel engaging means for engaging the vessel, a liquid flow passage for flow of liquid from the bottle to the vessel, an air return passage for flow of air from the vessel to the bottle, and a liquid distributor for distributing liquid in a path into the vessel.

At least in the preferred embodiments, there is provided a device for aerating wine that maximizes the distribution of the wine in a decanter, does not overly agitate the wine, may be used with a variety of decanters, and minimizes the risk of spillage.

The invention and its advantages will be better understood by reading the following non-restrictive description of a preferred embodiment thereof, made with reference to the accompanying drawings.

### BRIEF DESCRIPTION OF THE DRAWINGS

The invention will be better understood upon reading the following non-restrictive description of the preferred embodiments thereof, made with reference to the accompanying drawings in which:

FIG. 1 is an exploded view of a device according to a first preferred embodiment of the present invention;

FIG. 2 is a cross-sectional view of the device of the first embodiment;

FIG. 3 is a perspective view of a device according to a second preferred embodiment of the present invention;

FIG. 4 is a cross-sectional view of the device of the second embodiment.

### DETAILED DESCRIPTION OF PREFERRED EMBODIMENTS OF THE INVENTION

In the following description, the same numerical references refer to similar elements. The embodiments shown in the figures are preferred, for exemplification purposes only.

In the context of the present description, the expression “vessel” includes all types of liquid vessels as apparent to a person skilled in the art. For this reason, the expressions “decanter” or “carafe”, for example, include all other kinds of usages or items with which the present device may be used and could be useful.

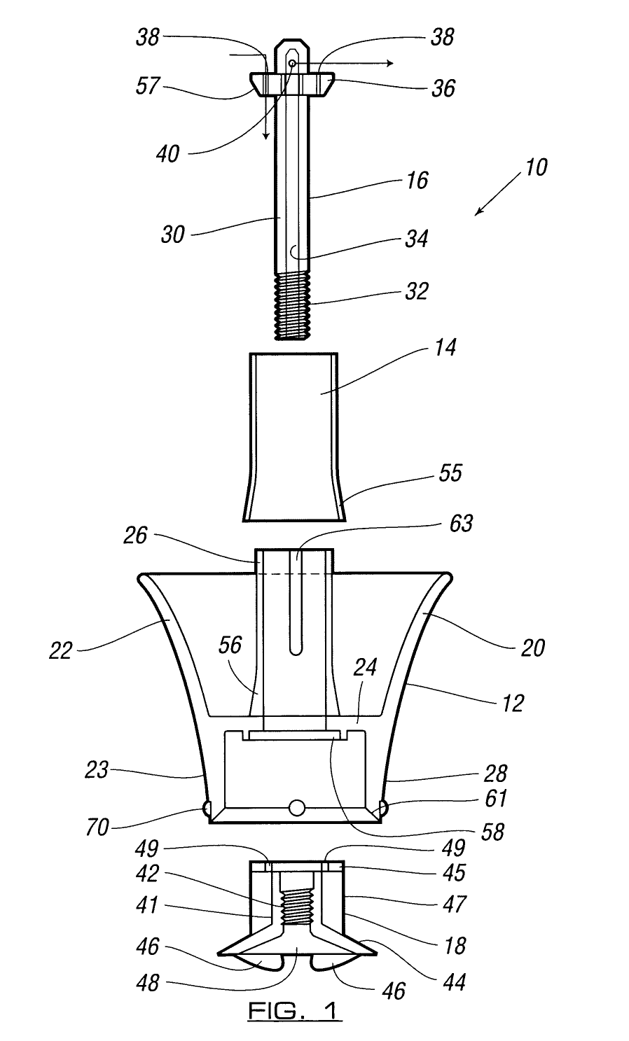

With reference to FIG. 1, a wine aerator 10 is shown including a cup 12 and a sleeve 14 held between a wedge screw 16 and a splasher 18. The cup 12 includes an upper portion 20 and a lower portion 28, separated by a wall 24. The upper portion includes an upper flange 22 which extends upwardly from the wall 24 and the lower portion includes a lower flange 23 which extends downwardly from the wall 24. Preferably, the upper flange 22 also tapers outwardly away from the wall 24. Within the upper portion 20 is a cup tube 26 onto which the sleeve 14 is fit. Preferably, the cup tube 26 is concentrically within the bowl portion 20 and extends upwards from the wall 24. Additionally provided is a tapering portion 56 which broadens the cup tube 26 at its base at the wall 24.

The wedge screw 16 comprises a hollow shaft 30 with a threaded portion 32 along the outer surface of the shaft 30 at a first end, a central channel 34 extending axially through the wedge screw 16, and a flange 36 extending radially outward from the shaft 30 at a second end opposite the first end. The flange 36 has an outer diameter greater than that of the tube 26 at its extremity, but less than that at the widest part of the tapering portion 56. The flange 36 has at least one hole 38 passing from one side of the flange 36 to the other. Preferably, the channel 34 is open at the second end by a hole 40 extending radially through the hollow shaft 3 in a direction substantially perpendicular to the holes 38. Preferably, the radial hole 40 is substantially smaller than the flange holes 38.

The splasher 18 comprises a neck 41, a splashing lip 44 extending radially outward therefrom at a first end, and an upper flange 45 extending radially outward therefrom at a second end opposite the first end. The neck 41 includes a threaded portion 42 which is complementary to, and engagable with, the threaded portion 32 of the wedge screw 16. Preferably, one or more vertical webs extend between the upper flange 45 and the lip 44 in order to strengthen the splasher 18.

A central channel 48 passes axially through the neck 41 between the splashing lip 44 and the flange 45 and connects with the channel 34 when the shaft 16 and the splasher 18 are joined. In addition, at least one secondary opening 49 is provided passing from one side of the upper flange 45 to the other. Preferably the splasher 18 fits within the lower portion 28 of the cup 12, and comprises at least one finger tab 46 for allowing a user to screw the wedge screw 16 and the splasher 18 together.

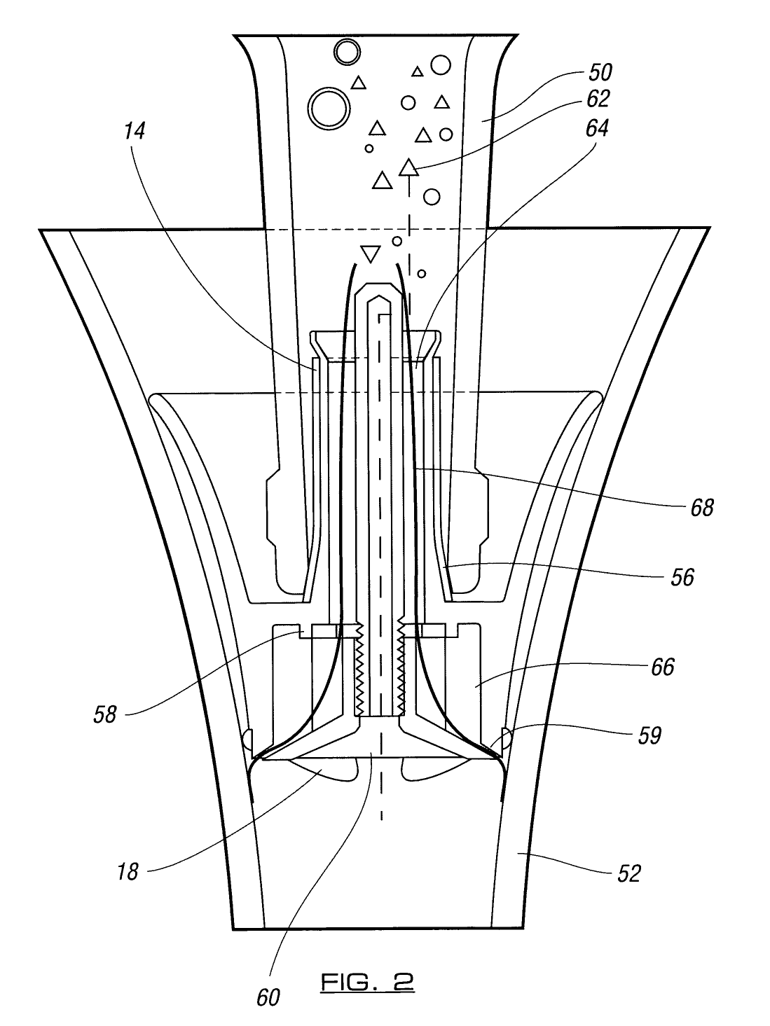

With additional reference now to FIG. 2, the wine aerator 10 is shown inserted in the neck of a wine bottle 50 and placed in a decanter 52 for enhancing aeration during the transfer of the wine 54 from the bottle 50 to the decanter 52.

In the illustrated assembled state, the sleeve 14 is fitted around and over the tube 26. The sleeve 14 is preferably a resilient tube made of an elastomeric material, for example a rubber or a silicone. Once the sleeve 14 has been properly placed on the tube 26, the wedge screw 16 is inserted through the tube 26 such that its first end extends into the lower portion 28 of the cup 12 and the flange 36 abuts and firmly engages the extremity of the tube 26. The shaft 30 of the wedge screw 16 is longer than the tube 26 and the threaded portion 32 therefore extends into the lower portion 28 of the cup 12.

A shoulder 58 is preferably provided on the wall 24 in the lower portion 28 of the cup 12 for aligning and receiving the splasher 18. Thus aligned, a circumferential opening 59 is left between the splashing lip 44 and the extremity of the lower flange 23. As illustrated, the opening 59 is an annular outlet passage. Advantageously, the splashing lip 44 is continuous around the neck 41 and provides a 360° distribution of the liquid exiting the aerator 10. Preferably, the extremity of the lower flange 23 has a chamfer 61 which is complementary to the angle of the splashing lip 44. As will be appreciated, the angle of the splashing lip 44, and hence that of the chamfer 61 as well, will effect the flow of the liquid as it exits the aerator 10. An alternate embodiment is discussed herein below in which this angle is increased.

Preferably, the flange 36 of the wedge screw 16 is provided with a chamfer 57 which engages the upper extremity of the tube 26. The threaded portion 42 of the 15 splasher 18 is then operable to engage the correspondingly threaded portion 32 of the wedge screw 30 thereby sandwiching the cup 12 and the sleeve 14 therebetween when tightened.

Thus assembled, the sleeve 14 is retained to the outside of the tube 26 between the flange 36 of the wedge screw 16, and the wall 24 of the cup 12. The sleeve 14 seals against the mouth of the wine bottle at the tapering portion 55. In addition, the tube 26 includes slits 63 which extend from the upper extremity of the tube 26 down towards the base 56 thereof which is also tapered. The slits 63 preferably extend to tapering section 56, and give the tube 26 a flexibility that allows the expansion of the tube 26 at its upper extremity.

In this manner, with the splasher positioned in shoulder 58 and threadedly engaging the wedge screw 16, the tightening of these two together will draw the flange 36 of the wedge screw towards the splasher 18. As a result, the chamfer 57 will push the tube 26 outwards as it is drawn therein.

This tapering and expandability is advantageously utilized to stabilize the aerator 10 within the bottle neck 50 by allowing the user to fit the wine aerator 10 with different sized bottle necks.

Alternatively, a tube 26 may be provided which expands outwardly, in which case similar slits 63 would allow the tube 26 to bend inwardly upon insertion into the bottle 50, thereby biasing the tube 26 against the bottle neck.

While the embodiment illustrated in FIGS. 1 and 2 shows the sleeve 14 and tube 26 both comprising a lower tapering portion 55, 56, in an alternative embodiment equally within the scope of the present invention, the sleeve 14 may be provided with a substantially constant diameter and simply stretched over the tapering portion 56 of the tube 26.

The central channel 34 of the wedge screw 16 aligns with, and is sealingly connected via the threaded portions 32 and 42 to the channel 48 of the splasher 18 forming a primary passage 60 which extends axially through the wine aerator 10 from the channel 48 to the hole 40 through the hollow shaft 30. This primary passage 60 allows air to flow from inside the decanter, upwards and into the wine bottle 50, as indicated by arrow 62, thereby aiding the smooth transfer of wine into the decanter 52.

The inner diameter of the tube 26 is sufficiently greater than the outer diameter of the hollow shaft 30 that a first outer chamber 64 is created therebetween which surrounds the unthreaded portion of the shaft 30. Similarly, the inner diameter of the lower flange 23 is sufficiently greater than the outer diameter of the neck 41 that a second outer chamber 66 is created therebetween.

These outer chambers 64 and 66 are concentric with the central channel 34 and in 30 communication with one another via the openings 49 in the upper flange 45. Together the outer chambers 64 and 66 form a secondary passage 68 which extends from the hole(s) 38 to the opening 59, through the spaces created between the tube 26 and the shaft 30, and the lower flange 23 and the neck 41. The secondary passage 68 allows liquid to flow from inside the wine bottle 50 downwards into the decanter 52.

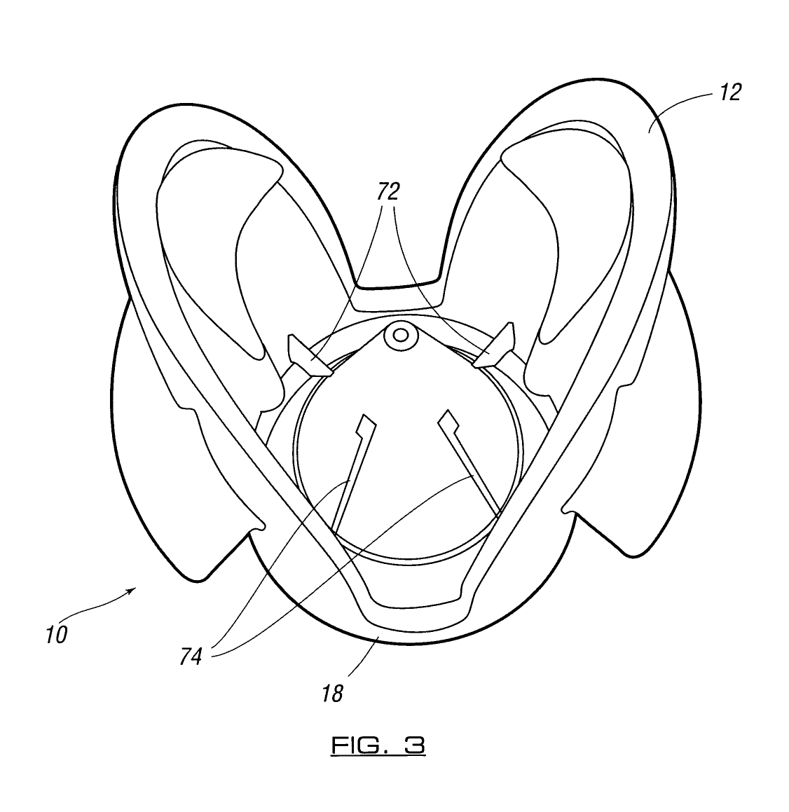

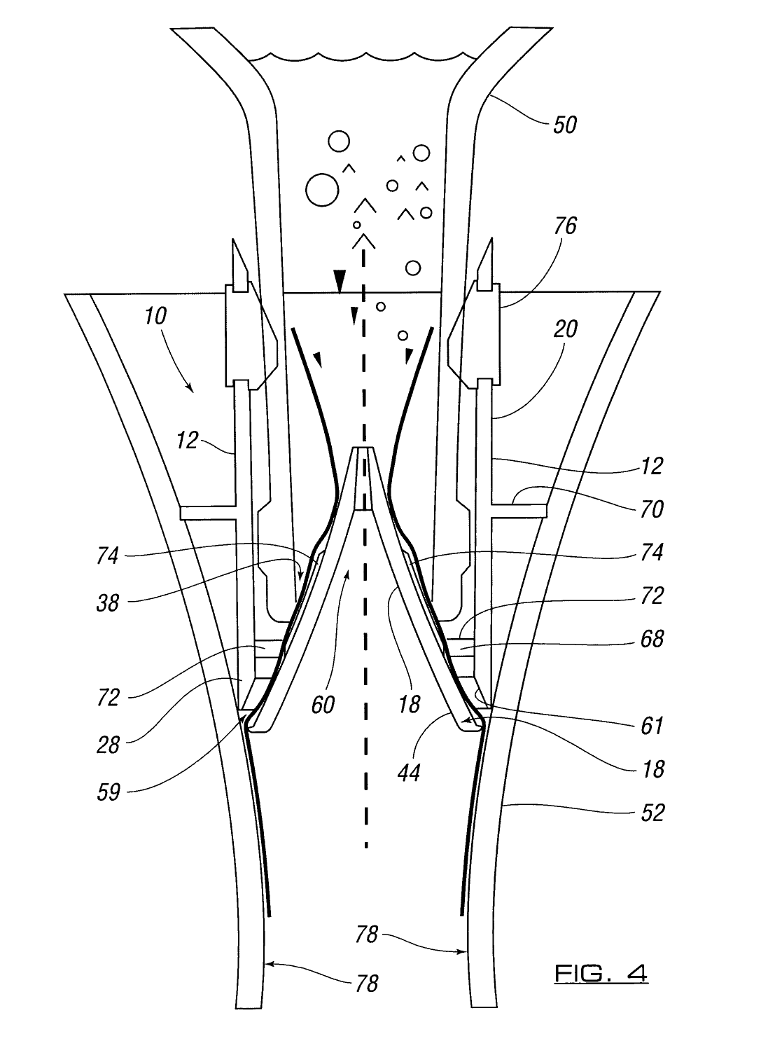

In use, the wine aerator 10 is assembled and inserted into an uncorked bottle 50. The tube 26, sleeve 14 and wedge screw 16 are inserted as far as possible into the neck of the bottle 50 so that a seal is created between the sleeve 14 and the bottle's mouth. The bottle 50 and wine aerator 10 are then inserted into the mouth of the decanter 52 as seen in FIGS. 3 and 4.

As gravity pulls the wine 54 down into decanter 52, a corresponding volume of air inside the decanter is pushed upwards into the bottle in order to replace it. Although at first both air and wine can flow through both the air and liquid passages 60 and 68, because of the orientation and size of the hole 40 at the top of the air passage 60 the flow of wine therethrough will be greatly limited. In contrast, the air flowing up from the decanter 52 into the bottle 50 will have little trouble passing through the hole 40. In the preferred embodiment, the flow of the air and wine will stabilize after a brief initial period, typically about a couple of seconds, and air will begin to flow through solely through the primary passage 60 and the wine will flow solely through the secondary passage 68. In this state, the wine will collect in the lower portion 23 of the cup before being expelled through the opening 59. Advantageously, the complementary angles of the splashing lip 44 and the chamfer 61 enable a continuous 360° splashing of the wine through the opening 59 and onto the sides of the decanter 52. Due to surface tension, the wine flows down the side of the decanter, even as the width of the decanter expands outward. As the decanter expands, the thickness of the wine “film” running down its inner wall is reduced, thereby exposing more of the wine to the air. This controlled and continuous splashing maximizes the exposure of the wine to the air as it is poured into the decanter in a continuous and distributed manner. As will be apparent to one of ordinary skill in the art, as air travels up the primary passage 60, out of the hole 40 and into the bottle 50, it will bubble through any wine which has not yet been transferred into the decanter 52, thereby further aerating the wine.

Spacers 70 are additionally provided which extend outwardly from the exterior of the aerator 10. The spacers 70 are provided to create a gap between the outside of the cup 12 and the inside of the decanter 52 proximate the opening 59. In use, a capillary action of the wine between the cup 12 and decanter 52 may be advantageously controlled. Gaps of a certain size may promote or restrain capillary action, as desired. Were the cup 12 to touch decanter 52 directly, the wine could overflow.

An alternate embodiment of the present device is illustrated in FIGS. 3 and 4. Herein, the angle of the splasher 18 is increased such that the liquid flows out of the aerator more vertically than as described above. This alternate taper angle of the splasher 18 advantageously provides a smoother flow to the liquid during decanting.

The cup 12 is similarly provided for holding the bottle 50, however the wedge screw 16 and splasher 18 have been combined into a unitary splasher 18. The increased taper angle of the splasher 18 allows the splasher 18 to extends inwards, within the neck of the bottle 50.

The cup 12 includes an upper portion 20 and a lower portion 28. The two portions 20 and 28 are separated by at least one rib 72 which connects the splasher 18 and the cup 12. Preferably, a plurality of ribs 72 are provided around the splasher 18. The openings 49 are formed between the splasher 18 and the cup 12 between the plurality of ribs 72. In the illustrated embodiment, four such ribs 72 are shown, although it will be apparent that less or more may be provided according to the desired flow and rigidity of the aerator 10.

As in the previous embodiment, the splasher 18 comprises the splashing lip 44 at its lower end for directing the flow of liquid outward, towards the walls of the decanter 52, however the body of this lip 44 now smoothly transitions into the remainder of the splasher 18 as it tapers inwards, into the upper portion 20 of the cup 12 and, ultimately, the bottle 50. As such, the primary passage 60, through which air travels from the decanter 52 into the bottle 50 during decanting, is provided centrally through the splasher 18. As before, the passage 60 terminates at its upper end with a hole 40.

The splasher 18 further comprises a spacer 74, which engages the mouth of the bottle 50 and similarly provides the openings 38 through which liquid may flow from the bottle 50 into the aerator 10. Preferably, a plurality of spacers 74 extend along the tapered surface of the splasher 18 and, as will be appreciated, are operable engage a variety differently dimensioned bottles 50, Bottles 50 having a smaller mouth and/or neck will rest upon the spacers 74 higher up on the splasher 18 while those having a larger mouth and/or neck will rest lower, closer to the splashing lip 44.

The functioning of the splashing lip 44 remains unchanged. The lower extremity of the cup 12 similarly comprises a chamfer 61 which is complementary to the angle of the lip 44. The circumferential opening 59, through which liquid exits the aerator 10, is created between the chamfer 61 and the lip 44.

The bottle 50 is further engaged by a pair of bumpers 76 which are provided at the upper end of the cup 12 and clasp the bottle neck from either side. As with the resilient sleeve 14 of the first embodiment, the bumpers 76 are preferably made of an elastomeric material, such as rubber or silicone.

The spacers 70 extend radially outwards from the cup 12 and serve to brace the aerator 10 against the decanter 50.

During decanting, liquid is allowed to flow downwards from the bottle 50 into the decanter 52 through the secondary passage 68, which is formed between the cup 12 and the splasher 18. The liquid runs through the openings 38 between the bottle mouth and the splasher 18, along the exterior of the splasher 18, through the openings 49 between the splasher 18 and the cup 12, along the splashing lip 44, out the circumferential opening 59 and outwards towards the inner walls 78 of the decanter 52.

Although the aerator 10 can function in various commonly-sized decanters 52, it is preferably sold together with a matching decanter 52. A decanter drying stand (not pictured) may also be provided therewith.

In the preferred embodiment, a standard 750 ml bottle of wine will be emptied into a decanter in about 60 seconds.

As will be apparent to one of ordinary skill in the art, small amounts of air may indeed flow up through the primary passage and small amounts of wine may flow down through the secondary passage while still accomplishing the desired dispensing and aeration.

Preferably, all the elements of the wine aerator 10 described herein, with the exception of the resilient sleeve 14 of the first preferred embodiment are made of a clear rigid plastic, for example a plastic from the polycarbonate or acrylic groups.

1. A device for simultaneously pouring a liquid from a bottle into a vessel and mixing air into the liquid comprising bottle engaging means for engaging the neck of a bottle, vessel engaging means for engaging the vessel, a liquid flow passage for flow of liquid from the bottle to the vessel, an air return passage for flow of air from the vessel to the bottle, and a liquid distributor for distributing liquid in a path into the vessel.

2. A device as claimed in claim 1 wherein the liquid distributor comprises a surface which is angled outwardly in the direction of liquid flow and means for directing the liquid across the angled surface.

3. A device as claimed in either claim 1 or claim 2 wherein the liquid distributor comprises an annular outlet channel of the liquid flow passage.

4. A device as claimed in either claim 2 or claim 3 wherein the device has an axis which in use is generally aligned with the bottle and the liquid distributor has a pair of walls between which the liquid flows, the walls being angled outwardly with respect to the axis.

5. A device as claimed in any preceding claim wherein the liquid distributor distributes the liquid in a generally circular and expanding path.

6. A device as claimed in any preceding claim including a generally annular body comprising one or more body members, the vessel engaging means being carried by the body.

7. A device as claimed in claim 7 further comprising an insert mounted within the body, the insert providing the liquid flow passage.

8. A device as claimed in claim 7 wherein the bottle engaging means is at least partly provided on the insert.

9. A device as claimed in either claim 7 or claim 8 wherein the body and insert together define part of the liquid flow passage.

10. A device as claimed in any one of claims 7 to 9 wherein the insert has a generally conical outer surface portion which, in use, is received in the bottle neck.

11. A device as claimed in any one of claims 7 to 10 wherein the insert has a generally conical outer surface position which forms part of the liquid distributor.

12. A device as claimed in claim 11 wherein the body has an angled lip which together with the conical outer surface portion forms the liquid distributor.
